(19) United States
(12) Patent Application Publication
(10) Pub. No.: US 2009/0058206 A1
(43) Pub. Date: Mar. 5, 2009

(54) MOTOR WINDING ASSEMBLY

(76) Inventor: Ronald Dean Bremner, Cedar Falls, IA (US)

Correspondence Address: DEERE & COMPANY, ONE JOHN DEERE PLACE, MOLINE, IL, 61265, US

(21) Appl. No.: 11/846,641

(22) Filed: Aug. 29, 2007

(51) Int. Cl. H02K 9/22; H02K 5/04

(52) U.S. Cl. 310/64; 310/89

(57) ABSTRACT

The invention relates to a motor winding assembly. There is a need for a motor winding assembly which rapidly conducts heat from motor coils to a cooling housing. An electric motor stator assembly has a plurality of winding assemblies enclosed by a heat conducting housing. Each winding assembly has a heat conducting lamination member, a pair of end cap insulator members next to the lamination member, and an insulating liner and an electrical winding wound around the lamination member and the end cap insulator members. Each end cap insulator member has a head, a foot, and a bar which extends between the head and the foot. The end cap insulator members are formed of a heat conducting material. Each head has a radially outer end which engages the heat conducting housing.

### FIELD OF THE INVENTION

The present invention relates to a winding assembly for an electric motor stator assembly.

### BACKGROUND OF THE INVENTION

Electric motors generate heat because of electrical resistance in the coil. Heat is generated in the stator laminations due to magnetic hysteresis and eddy currents. The heat generated in the coils typically passes through the stator to the housing. The housing then removes this heat by convection to air or liquid. Some of the heat is also conducted to the frame, and in some cases heat is removed by radiation. In some cases heat is conducted away by oil sprayed on the end windings, or oil flowing past the end windings. The heat generated in the stators flows through the stator steel, and into the housing. Sometimes, channels (which are punched into the stator) also conduct heat away from the stator by convection.

Some motors use special laminations, call T-laminations (because they have a T shape) which allow the coils to be wound more compactly. By winding the coils more compactly, the heat flows through the coil more effectively, keeping the coils cooler. However, there is still significant heat rise from the coil to the housing, due to the relatively low thermal conductivity of the steel as compared to the copper wires. In these stators, an end cap insulator, typically made of plastic, is placed under the wires, to keep the wires from shorting to the stator. In many motors, the stator is potted with a plastic which has better thermal conductivity than air, but less than metals.

### SUMMARY OF THE INVENTION

Accordingly, an object of this invention is to provide an electric motor stator winding assembly which improves motor cooling.

This and other objects are achieved by the present invention, wherein an electric motor stator assembly has a plurality of winding assemblies enclosed by a heat conducting housing. Each winding assembly has a heat conducting lamination member, a pair of end cap insulator members next to the lamination member, and an electrical winding wound around the lamination member and the end cap insulator members. The end cap insulator members are formed of a heat conducting material. Each end cap insulator member has a head, a foot, and a bar which extends between the head and the foot. Each head has a radially outer end which engages and transfers heat to the heat conducting housing.

### BRIEF DESCRIPTION OF THE DRAWINGS

FIG. 1 is a perspective partially exploded view of a motor stator assembly embodying the invention; and

FIG. 2 is a sectional view taken along lines 2-2 of FIG. 1.

### DESCRIPTION OF THE PREFERRED EMBODIMENT

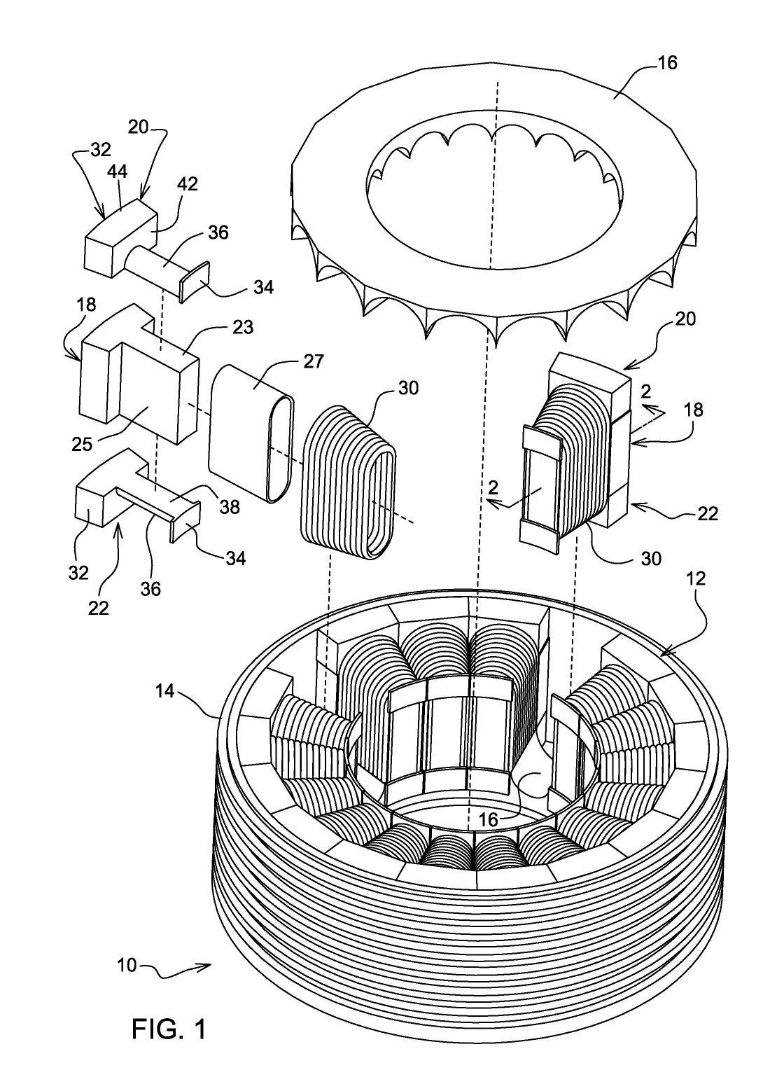

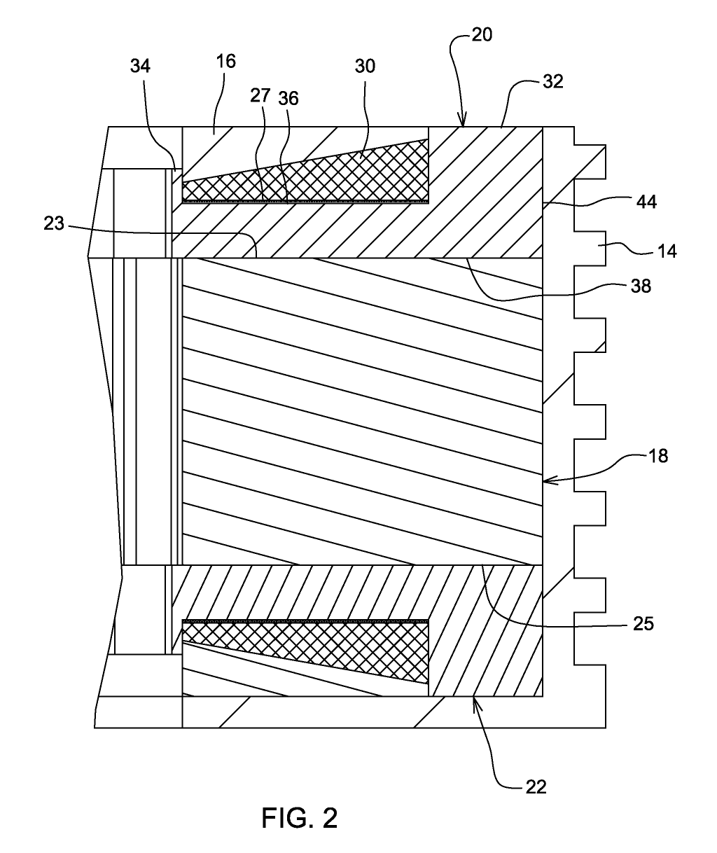

Referring to FIGS. 1 and 2, an electric motor stator assembly 10 includes a plurality of winding assemblies 12 held in a cylindrical heat conducting (water or air cooled) housing 14 by conventional potting 16 which is molded in place. Each winding assembly 12 has a heat conducting lamination member 18, an upper end cap insulator member 20 and a lower end cap insulator member 22. The end cap insulator members 20 and 22 engage axially facing opposite end surfaces 23 and 25 of the lamination member 18. A liner 27 is wrapped around the lamination member 18 and the end cap insulator members 20 and 22. The liner 27 is preferably formed out of a material which is heat conducting and electrically insulating, such as Nomex or Kapton. A conventional electrical winding 30 is wound around the lamination member 18 and the end cap insulator members 20 and 22, outside of the liner 27.

Each end cap insulator member 20, 22 includes a heat conducting head 32, a heat conducting foot 34, and a heat conducting bar 36 which extends between the head and the foot. The bar 36 has a flat inner surface 38 which engages the axially facing end surface 23, 25 of the lamination member 18 and has a curved outer surface 40 which engages the electrical winding 30. Each head 32 includes a radially inner surface 42 which engages a radially outer end of the winding 30, and a radially outer surface 44 which engages an inner surface of the housing 14. Each end cap insulator member 20, 22 is formed of a heat conducting material, preferably aluminum or copper. Alternatively, the end cap insulators could be made of a non-electrically conductive material which conducts heat, in which case the liner 27 could be eliminated.

With this design, heat generated by the windings 30 is conducted by the bar 36 and the head 32 of the end cap insulator members 20, 22 to the cooling housing 14, and is also conducted to the housing 14 via the lamination member 18.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. In an electric motor stator assembly having a plurality of winding assemblies enclosed by a heat conducting housing, each winding assembly having a heat conducting lamination member, a pair of end cap insulator members engaging axially facing opposite end surfaces of the lamination member, and an electrical winding wound around the lamination member and the end cap insulator members, the improvement wherein:
at least one of the end cap insulator members is formed of a heat conducting material and has a radially outer end which engages the heat conducting housing.

2. In an electric motor stator assembly having a plurality of winding assemblies enclosed by a heat conducting housing, each winding assembly having a heat conducting lamination member, a pair of end cap insulator members engaging axially facing opposite end surfaces of the lamination member, and an electrical winding wound around the lamination member and the end cap insulator members, each end cap insulator member having a head, a foot and a bar which extends between the head and the foot, the improvement wherein:
each end cap insulator member is formed of a heat conducting material and the head of each end cap insulator member has a radially outer end which engages the heat conducting housing.

3. The electric motor stator assembly of claim 2, wherein:
the head includes a radially inner surface which engages a radially outer end of the winding, and a radially outer surface which engages an inner surface of the housing.
